(19) United States
(12) Patent Application Publication
(10) Pub. No.: US 2006/0138953 A1
(43) Pub. Date: Jun. 29, 2006

(54) Display device

(76) Inventors: Kenji Kato, Mobara (JP); Yoshie Kodera, Chigasaki (JP); Toshio Sasamoto, Hamura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/318,560

(22) Filed: Dec. 28, 2005

(30) Foreign Application Priority Data
Dec. 28, 2004 (JP) 2004-379820

(51) Int. Cl. H01J 19/70

(52) U.S. Cl. 313/553; 313/496

(57) ABSTRACT

An envelope is constituted by sandwiching and fixing a frame between a back substrate having an electron emission region and a face substrate having an image display region. A recessed portion is formed in a corner portion of the frame, a getter assembly is arranged in the recessed portion, and the getter assembly is fixed to the frame. Due to such a constitution, it is possible to provide a display device which can install a sufficient getter without interrupting the narrowing of a picture frame.

### CROSS-REFERENCE TO RELATED APPLICATION

The present application claims priority from Japanese application JP2004-379820 filed on Dec. 28, 2004, the content of which is hereby incorporated by reference into this application

### BACKGROUND OF THE INVENTION

1. Field of the Invention

The present invention relates to a display device, and more particularly to a display device which includes a getter assembly.

2. Description of the Related Art

As a display device which performs a display by allowing a phosphor screen to emit lights when electrons impinge on the phosphor screen, besides a cathode ray tube, there has been known a field emission display which includes field emission electron sources. With respect to a thin cathode ray tube which is represented by the field emission display, it is necessary to hold the inside of a vessel in a high vacuum state so as to facilitate the movement of electrons. Here, the thin CRT is also referred to as a planar display or a flat panel display device.

In this type of flat panel display device, a getter is provided between a back substrate and a face substrate. Accordingly, to prevent a getter material from being scattered to electron emission elements, a barrier is provided. In the conventional display device, to separate the electron emission elements and the getter from each other, a peripheral portion including an image display region occupies a large area. Accordingly, the conventional display device is required to reduce an image display region part or to increase the image display region part by an amount corresponding to a portion where the getter is mounted. When a non-evaporation-type getter is arranged between the back substrate and the face substrate, it is necessary to ensure a volume which can efficiently absorb gas remaining in a vessel. Further, to use the evaporation-type getter, it is necessary to arrange the getter at a position sufficiently spaced apart from the display region such that the electron emission elements are not covered with a scattered getter material. JP-A-7-140906 (patent document 1) discloses a technique which ensures a required getter material adhesion area by making portions of the electron emission elements where the getter material is adhered coarse.

### SUMMARY OF THE INVENTION

In the conventional display device, the getter is mounted on a back surface or a peripheral portion of the display device. Accordingly, to sufficiently increase a remaining gas absorption ability of the getter, it is necessary to increase an image non-display region and this situation has been one of the obstacles which hampers the satisfying of a request for narrowing a so-called picture frame.

Accordingly, it is an object of the present invention to provide a display device which can arrange a sufficient getter without obstructing the narrowing of a picture frame.

The present invention has been made to overcome the above-mentioned drawbacks of the related art and it is an object of the present invention to provide a display device which arranges a getter between a back substrate and a face substrate without widening a non-image display region which surrounds an image display region. The typical constitution of the display device according to the present invention is directed to a display device which includes an envelope which is formed by fixing a back substrate having electron emission regions and a face substrate having an image display region while sandwiching a frame (sealing frame) therebetween and evacuates the inside of the envelope, wherein the frame is arranged to respectively surround electron emission regions of the back substrate and image display regions of the face substrate and fixes getters accommodated in the inside of the envelope to the frame. Due to the above-mentioned constitution, it is possible to overcome the drawbacks of the conventional display device.

According to the display device of the present invention, it is possible to arrange the getter in the inside of an activated environment (space in which electron sources are formed) without reducing an area of the display region or without increasing a width of a picture frame. When a non-evaporation-type getter is used, it is possible to efficiently absorb gas remaining in a vessel. Here, although it is possible to use the evaporation-type getter, in this case, a barrier is provided at an opening of a getter accommodating portion to prevent the scattered getter from being adhered to the electron emission elements.

### BRIEF DESCRIPTION OF THE DRAWINGS

FIG. 1 is a perspective view from a front side for explaining an embodiment 1 of a display device according to the present invention;

FIG. 2 is an enlarged view of a corner portion of a frame at which a getter assembly is arranged;

FIG. 3 is an enlarged view for explaining another shape of the corner portion of the frame at which the getter assembly is arranged;

FIG. 4 is a cross-sectional view of the getter assembly when the getter assembly is arranged in the inside of a panel;

FIG. 5 is a top plan view of the getter assembly;

FIG. 6 is a cross-sectional view similar to FIG. 4 which explains a state after an evaporation-type getter is heated with high frequency and is vapor-deposited to an inner surface of a face substrate;

FIG. 7 is an enlarged view of a corner portion of a frame at which a getter assembly is arranged for explaining an embodiment 2 of the present invention;

FIG. 8 is an enlarged view for explaining another shape of the corner portion of the frame at which the getter assembly is arranged;

FIG. 9 is a perspective view from a front side for explaining an embodiment 3 of the display device according to the present invention;

FIG. 10 is a front view of aback substrate of the display device according to the present invention for explaining an example of the arrangement of wiring which is formed on the back substrate and drive circuits which are mounted on a periphery of the back substrate;

FIG. 11 is a schematic cross-sectional view for explaining an example of the arrangement of a phosphor screen which is formed on the face substrate of the display device according to the present invention;

FIG. 12 is a schematic cross-sectional view for explaining the whole constitution of the display device according to the present invention;

FIG. 13 is a flow chart for explaining the summary of the manufacture of the display device according to the present invention;

FIG. 14 is a perspective view from a front side for explaining an embodiment 4 of the display device according to the present invention; and

FIG. 15 is a perspective view from a front side for explaining an embodiment 5 of the display device according to the present invention.

### DETAILED DESCRIPTION OF THE INVENTION

Specific embodiments of the present invention are explained in detail hereinafter in conjunction with drawings which show the embodiments.

### Embodiment 1

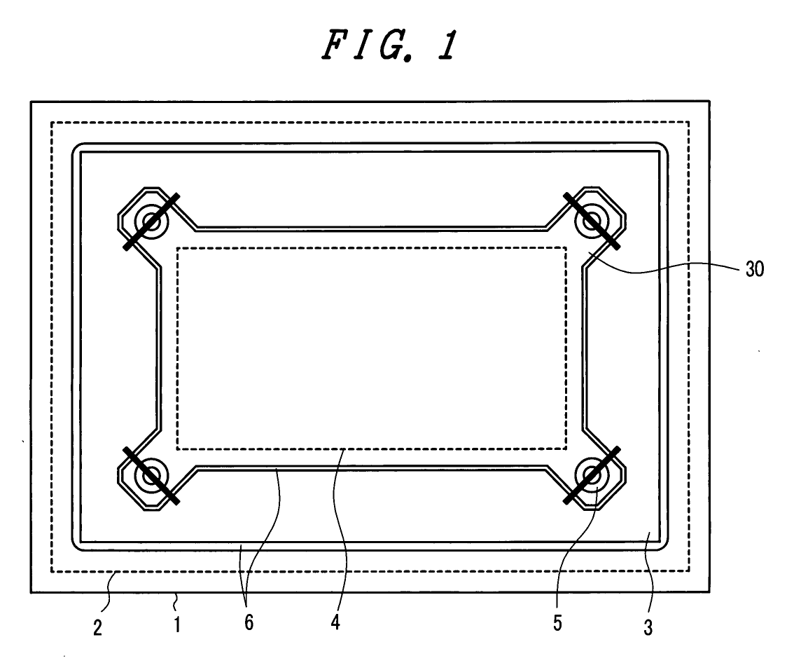

FIG. 1 is a perspective view from a front side for explaining an embodiment 1 of a display device according to the present invention. The display device constitutes an envelope by fixedly securing aback substrate 1, a face substrate 2 and a frame (sealing frame) 3 using frit glass 6. Here, in the drawings described hereinafter, unless particularly necessary, the illustration of the frit glass is omitted. A profile line of the face substrate 2 is indicated by a broken line. The inside of the envelope is evacuated and is held in a high vacuum. The back substrate 1 includes an electron emission region (display region) 4 indicated by a dotted line. A plurality of electron emission elements which are individually controlled are formed in the electron emission region 4. The face substrate 2 includes an image display region (a phosphor forming region which faces the display region 4) and black matrix layers, phosphor layers and an anode are formed in the image display region.

The frame 3 is arranged in a state that the frame 3 is sandwiched between a surface of the back substrate 1 on which the electron emission elements are formed and a surface of the face substrate 2 on which the phosphor layers are formed. Further, the frame 3 is arranged to surround the electron emission region and the image display region and is adhered to the back substrate 1 and the face substrate 2 using the frit glass 6. Further, getter assemblies 5 are arranged in the inside of the envelope. The getter assemblies 5 are fixed to the frame 3. The frame 3 is formed in a rectangular shape which has long sides and short sides which substantially trace a profile of the display device. Recessed portions for accommodating the getter assemblies 5 are provided to corner portions of the frame 3. Each recessed portion is formed in a state that the recessed portion has an opening at an inner side of the envelope.

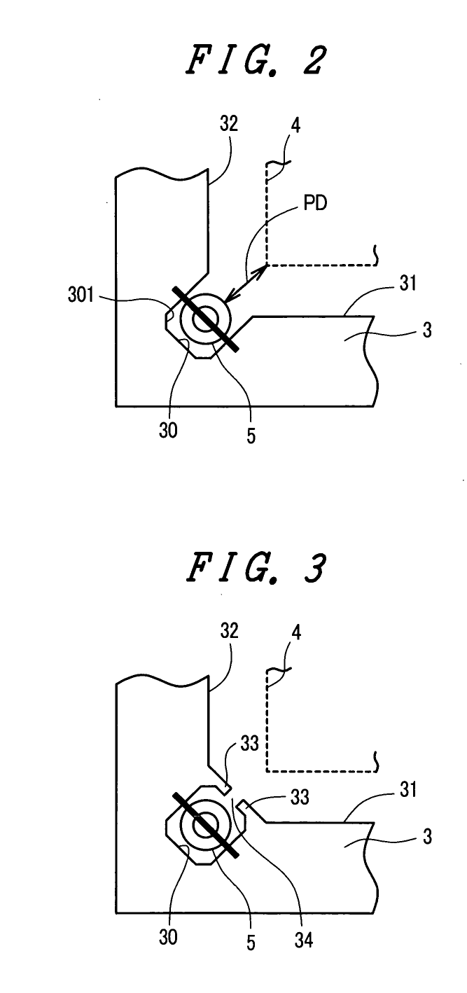

FIG. 2 is an enlarged view of the corner portion of the frame 3 in which the getter assembly 5 is arranged. Parts identical with the parts shown in FIG. 1 are given same numerals. The frame 3 includes the recessed portion 30 in the corner portion, and the getter assembly 5 is accommodated in the recessed portion 30. Here, a housing (described later) which accommodates a getter is not brought into contact with the frame 3. When the getter is heated using high frequency, the housing which accommodates the getter also assumes a high temperature. When the housing which assumes the high temperature is brought into contact with the frame 3, the frame 3 may rupture. By preventing the housing and the frame 3 from coming into contact with each other, it is possible to prevent the frame 3 from being cracked.

The getter assembly 5 is arranged in the inside of the recessed portion 30 which is formed on an extension of an inner wall of the long side of the frame 3 and an extension of an inner wall of the short side of the frame 3 which are arranged adjacent to each other or more outside (side away from the electron emission region) than an extension surface of the inner wall of the long side and an extension surface of the inner wall of the short side which are arranged adjacent to each other. By elongating a distance PD between the getter and the electron emission region, when the evaporation-type getter is used, it is possible to suppress the adhesion of a vapor deposition film of the getter to the electron emission elements. Here, when the non-evaporation-type getter is used, it is unnecessary to particularly take this point into consideration. Further, a chamfered portion 301 is formed on an inner wall of the recessed portion 30 of the frame 3. By forming the chamfered portion 301, portions having an angle of 90° or less are eliminated from the frame 3 and hence, the occurrence of cracks in the frame 3 can be prevented.

FIG. 3 is an enlarged view for explaining another shape of the corner portion of the frame 3 at which the getter assembly is arranged. FIG. 3 shows a shape which is suitable for the case in which the evaporation-type getter is particularly used, wherein an opening 34 is narrowed by forming bank portions 33 on an opening portion of the recessed portion 30. By allowing the recessed portion 30 to have such a shape, it is possible to further effectively suppress the adhesion of the vapor deposition film of the getter to the electron emission elements.

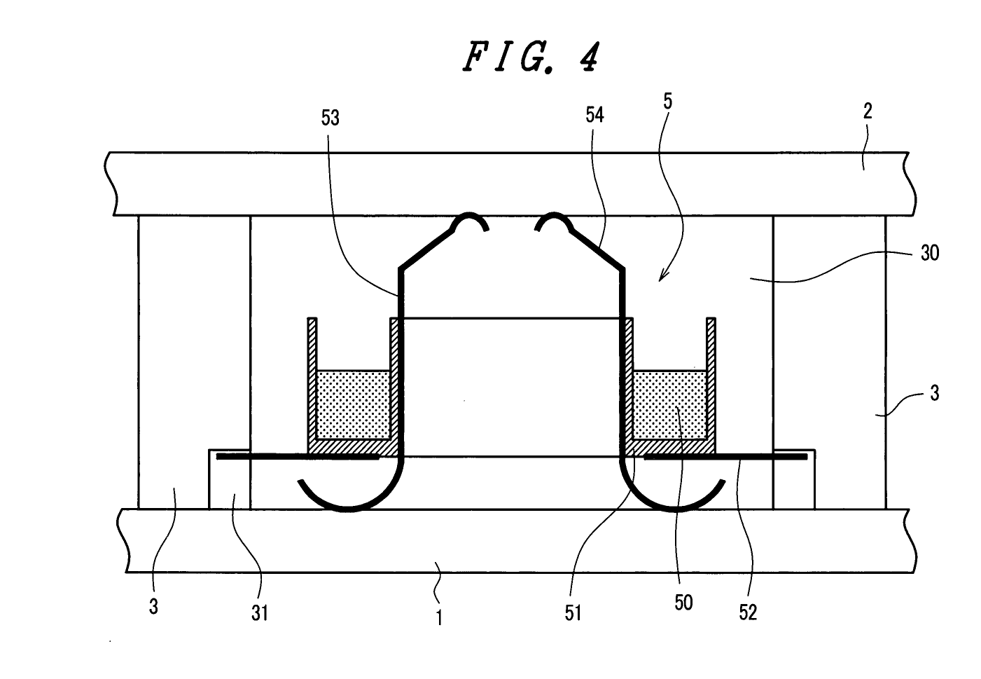

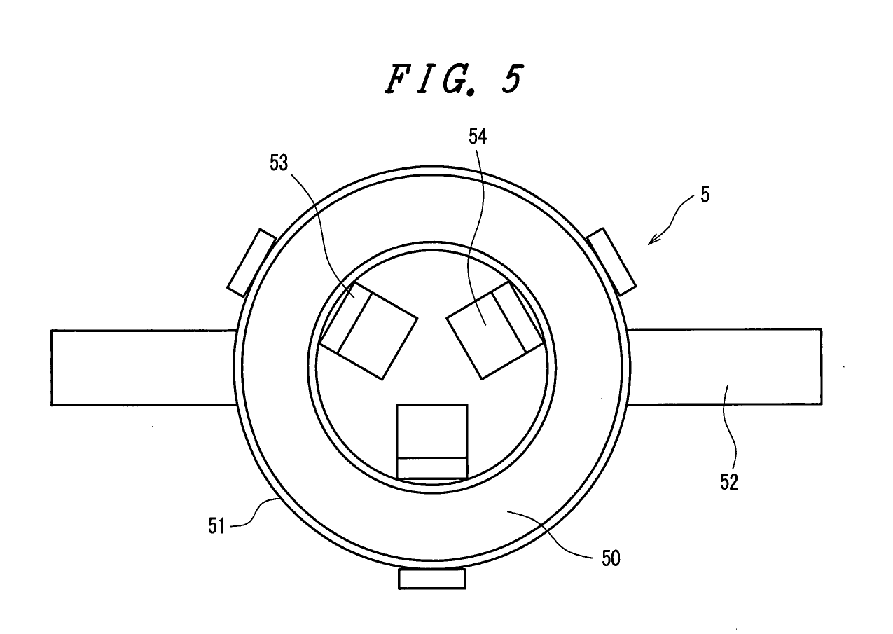

FIG. 4 is a cross-sectional view of the getter assembly when the getter assembly is arranged in the inside of a panel. Further, FIG. 5 is a top plan view of the getter assembly. In FIG. 4 and FIG. 5, the getter assembly 5 is arranged in the inside of the recessed portion 30 of the frame 3. Further, the getter assembly 5 is arranged in a state that the getter assembly 5 is sandwiched between the back substrate 1 and the face substrate 2. The getter assembly 5 includes a getter agent 50, a housing 51 which accommodates the getter agent 50, a support 53 which holds the housing 51, and positioning rods 52 which are served for positioning the getter assembly 5. The housing 51 is formed in a cylindrical and cup-like shape and has one end thereof opened.

The getter agent 50 which is accommodated in the housing 51 is held by the getter support 53. The getter support 53 includes springs 54 and fixes the getter assembly 5 in a state that the getter support 53 is sandwiched between the back substrate 1 and a room member. Both ends of the getter support 53 include curved surfaces and these curved surfaces are brought into contact with the back substrate 1 and the face substrate 2 and hence, the occurrence of cracks in the back substrate 1 and the face substrate 2 can be suppressed. Further, the positioning rods 52 are fixed to the housing 51. Due to a spring function of the getter support 53, the position in the thickness direction of the getter assembly 5 in a state that the back substrate 1 and the face substrate 2 are overlapped to each other is ensured, while due to the positioning rods 52, the position of the getter assembly 5 in the planner direction of the back substrate 1 and the face substrate 2 is ensured. Since the getter assembly 5 is positioned by the back substrate 1, the face substrate 2 and the frame 3, the position of the housing 51 can be controlled with high accuracy. Further, since the positioning rods 52 of the getter assembly 5 are directly fixed to the frame 3, it is possible to prevent the housing 51 from coming into contact with the frame 3. Further, at the time of fixing the frame and the substrate using the frit glass, by fixing the positioning rods 52 simultaneously with such a fixing operation, it is possible to simplify the manufacturing steps.

Notched portions 31 for positioning are formed in the recessed portion 30 of the frame 3. Free ends of the positioning rods 52 are inserted into these notched portions 31 and the mounting position of the getter assembly 5 is ensured by the positioning rods 52. Due to the combination of the positioning rods 52 and the notched portions 31, the positioning of the getter assembly 5 is facilitated and hence, the manufacture of the display device is facilitated.

Although the getter assembly 5 shown in FIG. 4 is fixed due to the spring function, the getter assembly 5 may be fixed by fixing the positioning rods to the frame 3. Further, the notched portions 31 are formed in surfaces of the frame 3 which face the back substrate. That is, open end of the housing 51 faces the face substrate 2 in an opposed manner. Since the open end of the housing 51 faces the face substrate, provided that the getter agent 50 is of an evaporation type, when the getter agent 50 is evaporated due to high frequency, it is possible to suppress the adhesion of the getter film to the electron emission elements in the display region 4.

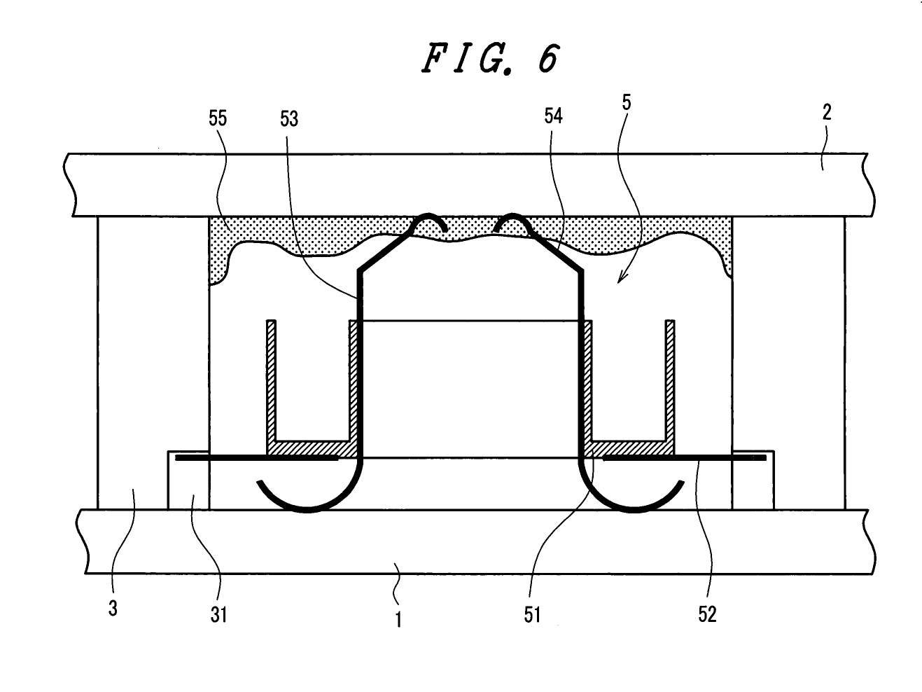

FIG. 6 is a cross-sectional view similar to FIG. 4 for explaining a state after the evaporation-type getter is vapor-deposited to an inner surface of the face substrate by heating the getter using high frequency. A getter film 55 after vapor deposition has a getter pumping function and can efficiently absorb a residual gas in the inside of a tube by ensuring a wide surface area. That is, when the non-evaporation-type getter is used, the getter agent absorbs the residual gas while remaining in the inside of the housing 51.

Due to the embodiment 1, without reducing the area of the display region or without increasing the width of the picture frame, it is possible to arrange the getter in the inside of the activated environment (the space in which electron sources are formed) and hence, it is possible to obtain the display device which exhibits a long lifetime and an excellent reliability.

### Embodiment 2

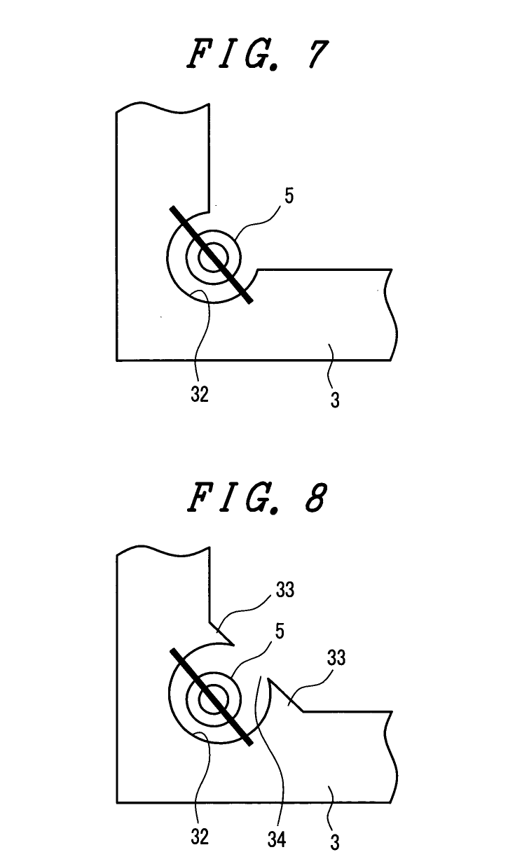

FIG. 7 is an enlarged view of a corner portion of a frame 3 at which a getter assembly is arranged for explaining an embodiment 2 of the present invention. Since constitutions other than the constitution of the corner portion are substantially equal to the corresponding constitutions of the embodiment 1, the repeated explanation is omitted. In FIG. 7, a recessed portion of the frame 3 which accommodates the getter assembly 5 therein is formed in an arcuate shape in a projection view as viewed from above. By forming the arcuate recessed portion 32, when the evaporation-type getter is used, it is possible to form a getter film in a wide region. Further, when a non-evaporation-type getter is used, the getter can smoothly absorb a residual gas in the inside of a vacuum vessel and any getter can enhance a gas absorption ability thereof. Since the number of corner portions of the frame PF can be reduced, the chipping of the frame PF can be suppressed.

FIG. 8 is an enlarged view for explaining another shape of the corner portion of the frame 3 at which the getter assembly is arranged. FIG. 8 shows a shape which is suitable for the case in which the evaporation-type getter is particularly used, wherein in the same manner as FIG. 7, an opening 34 is narrowed by forming bank portions 33 on an opening portion of the arcuate recessed portion 32. By allowing the recessed portion 32 to have such a shape, it is possible to further effectively suppress the adhesion of the vapor deposition film of the getter to the electron emission elements.

Also in the embodiment 2, in the same manner as the embodiment 1, it is possible to arrange the getter in the inside of an activated environment (a space in which electron sources are formed) without reducing an area of a display region and without enlarging a width of a picture frame, whereby it is possible to obtain a display device which exhibits the prolonged lifetime and the high reliability.

### Embodiment 3

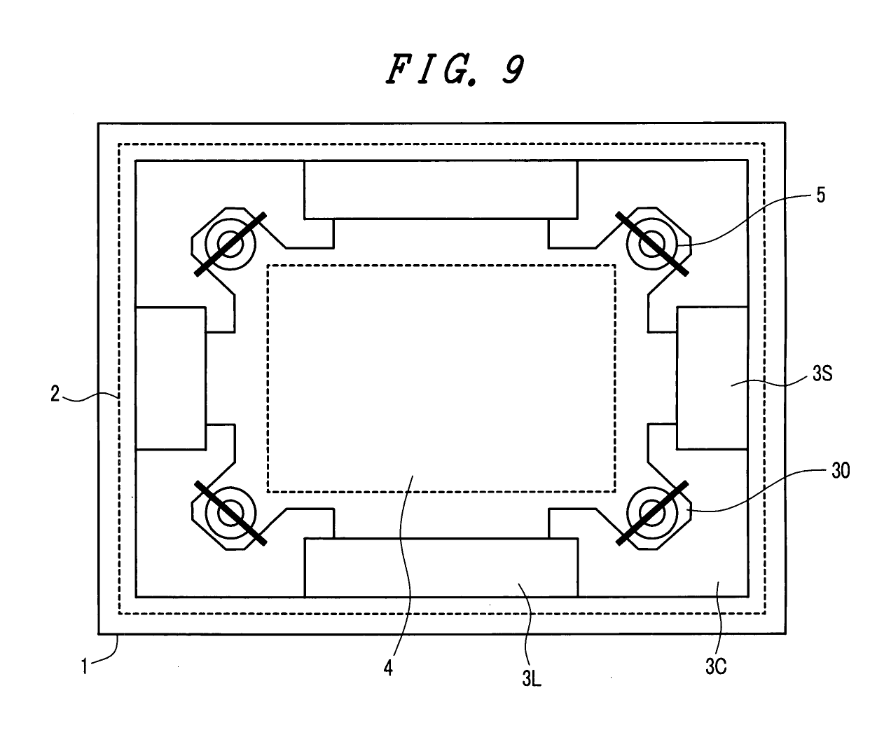

FIG. 9 is a perspective view from a front side for explaining an embodiment 3 of the display device according to the present invention. Parts identical with the parts shown in FIG. 1 are given the same symbols. In the embodiment 3, an envelope is constituted by fixedly securing a back substrate 1, a face substrate 2 and a frame 3 using frit glass not shown in the drawing. The inside of the envelope is evacuated and is held in a high vacuum. The frame 3 is constituted of long-side members 3L, short-side members 3S and corner members 3C. Getter assemblies 5 are arranged at the corner members 3C. The corner member 3C includes a recessed portion 30 and the getter assembly 5 is accommodated in the recessed portion 30. Although the getter assembly 5 is fixed due to a spring function as has been explained in conjunction with the embodiment 1, the positioning rods 52 shown in FIG. 4 and the like may be fixed to the notched portions 31 using an adhesive agent. Here, although the recessed portion 30 may be formed in a rectangular shape in the same manner as the recessed portion in FIG. 2 and FIG. 3, the recessed portion 30 may be formed in an arcuate shape as shown in FIG. 7 and FIG. 8. Other constitutions are substantially equal to the corresponding constitutions of the embodiment 1 and the embodiment 2.

Also in the embodiment 3, in the same manner as the embodiment 1, it is possible to arrange the getter in the inside of an activated environment (a space in which electron sources are formed) without reducing an area of a display region and without enlarging a width of a picture frame, whereby it is possible to obtain a display device which exhibits the prolonged lifetime and the high reliability.

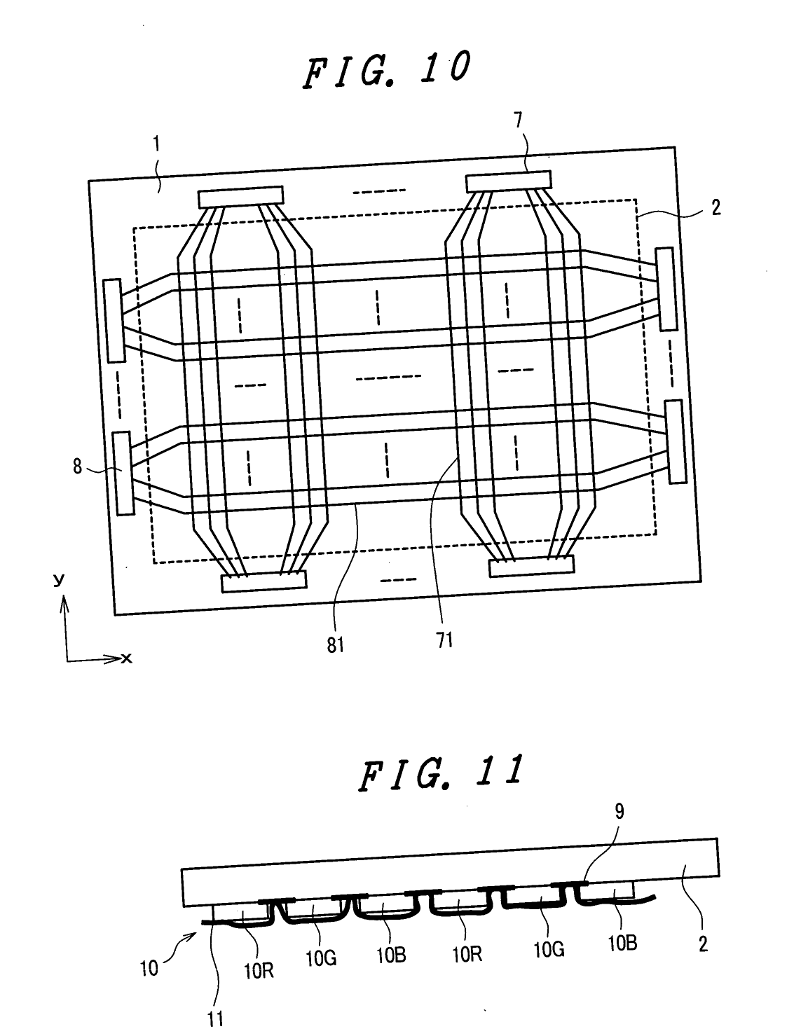

FIG. 10 is a front view of the back substrate of the display device according to the present invention for explaining an example of an arrangement of wiring which is formed on the back substrate and drive circuits which are mounted on a periphery of the back substrate. On a first plane (main surface) of the back substrate 1 which is preferably made of glass or a ceramics material, a plurality of data lines (or cathode lines) 71 which extend in the first direction (vertical direction=short-direction, y direction in FIG. 10) and are arranged in parallel in the second direction (lateral direction=long-side direction, x direction) which intersects the first direction, and a plurality of scanning lines 81 which extend in the second direction (x direction) and are arranged in parallel in the first direction (y direction) are formed. Electron emission sources are formed on intersecting portions of these lines which are arranged in a matrix array or in the vicinity of the intersecting portions.

The scanning lines 81 have one ends thereof connected to scanning line drive circuits 8. On the other hands, the data lines 71 have one ends thereof connected to data line drive circuits 7. The face substrate 2 is arranged in a state that a profile thereof is indicated by a broken line. The face substrate 2 and the back substrate 1 are adhered to each other along outer peripheries of opposedly facing regions thereof by way of the frame 3 (omitted from the drawing), and the inner gas is evacuated so as to seal the space defined between the face substrate 2 and the back substrate 1. Here, although both of the gate lines 81 and the data lines 71 are indicated as lines which adopt a both-side drive method in FIG. 10, the present invention is not limited to such a constitution. That is, there may be a case in which only the gate lines 81 adopt the both-side drive method, a case in which both of the gate lines 81 and the date lines 71 adopt a one-side drive method, or other cases.

FIG. 11 is a schematic cross-sectional view for explaining an example of an arrangement of a phosphor screen which is formed on the face substrate of the display device according to the present invention. On the face substrate 2, red phosphors 10R, green phosphors 10G, blue phosphors 10B and black matrixes 9 which are formed to partition the respective phosphors are formed thus constituting the phosphor screen 10. Here, the respective phosphors are formed in a state that the respective phosphors cover portions of the black matrixes 9. Over the phosphors 10R, 10G, 10B, a metal back 11 is formed, wherein the metal back 11 accelerates electrons from electron sources (electron emission elements) and allows the electrons to impinge on the phosphors so as to excite the phosphors such that phosphors emit light and, at the same time, efficiently reflect the emitted light and allow the light to be irradiated to the outside of the face substrate 2.

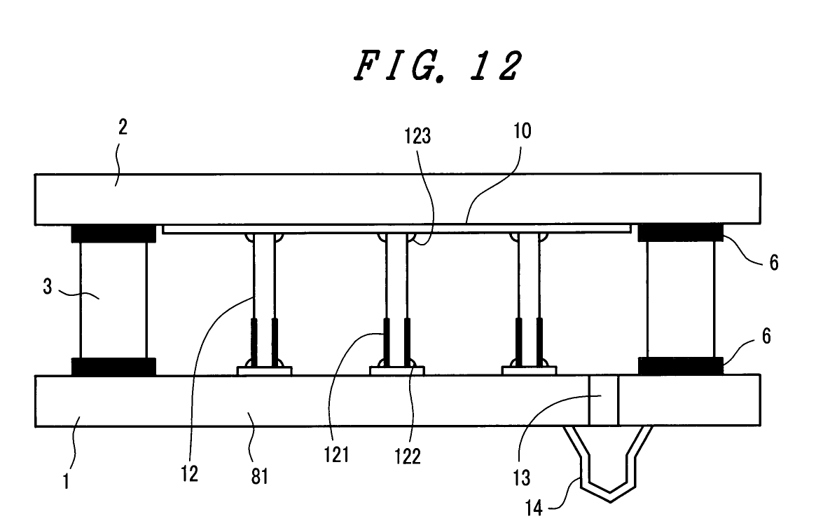

FIG. 12 is a schematic cross-sectional view for explaining the whole constitution of the display device according to the present invention. The back substrate 1 forms electron emission elements on one surface (main surface=inner surface) thereof and forms an exhaust pipe 14 for vacuum evacuation on another surface (back surface=outer surface) thereof. The exhaust pipe 14 is shown in a state that the space defined between the back substrate 1 and the face substrate 2 is sealed after vacuum evacuation (tip off state). The face substrate 2 forms a phosphor screen 10 on one surface (main surface=inner surface) thereof, wherein the phosphor screen 10 includes the phosphor layers and the metal back 11 which is formed above the phosphor layers 10 which are explained in conjunction with FIG. 11. Here, an aluminum vapor-deposited film is used as the metal back.

The surface of the back substrate 1 on which the electron emission elements are formed and the phosphor screen 10 of the face substrate 2 are arranged to face each other with the frame 3 therebetween. The back substrate 1 and the frame 3 are welded and fixed to each other using frit glass 6 and, at the same time, the face substrate 2 and the frame 3 are welded and fixed to each other using the frit glass 6 thus forming the envelope (or also referred to as vessel). With respect to the envelope, the gas in the inside of the envelope is discharged through the exhaust pipe 14 and, thereafter, the inside of the envelope is sealed by tipping off the exhaust pipe. In the inside of the envelope which is evacuated to a given vacuum, spacers 12 which prevent the face substrate 2 and the back substrate 1 from deflecting or indenting toward inside of the envelope are arranged. On the back-substrate-1 side of the spacer 12, a resistance layer 121 having a given resistance value to prevent a discharge between the back-substrate-1 side and the face-substrate-2 side is formed, and is adhered to the gate line using frit glass 122. Here, the face-substrate-2 side of the spacer 12 is also adhered to the face substrate 2 using frit glass 123.

In the display device having such a constitution, electrons are emitted from the electron emission elements which are formed on the back substrate 1. The emitted electrons advance toward the anode (metal back) which is formed on the face substrate 2. An anode voltage of several kV is applied to the metal back. That is, the metal back performs a reflection function as well as an anode function. The electrons emitted from the electron emission elements impinge on the phosphor screen 10 and allow the phosphors of three colors which constitute the phosphor screen to emit lights thus forming a color image. An observer can observe the emission of lights on the phosphor screen 10 through the face substrate 2.

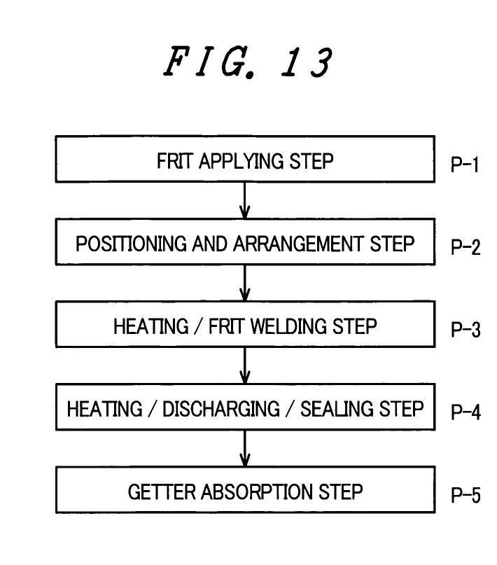

FIG. 13 is a flow chart for explaining the summary of the manufacture of the display device according to the present invention. In FIG. 13, first of all, the frit glass is applied to end surfaces of the room member (frit applying step: P-1). Next, after aligning the getter assembly, the getter housing and the like with the back substrate, these parts are arranged at given positions (positioning and arrangement step of respective members: p-2). Next, the frit glass is heated to weld the respective members using the frit glass (heating/frit welding step: P-3). Next, the vessel is heated and the gas in the inside of the vessel is discharged and the inside of the vessel is sealed (heating/discharging/sealing step: P-4). Next, the getter is heated so as to allow the getter to absorb the residual gas (getter absorption step: P-5). Here, when the evaporation-type getter is used, the getter is scattered by heating and the getter film which absorbs the residual gas is formed.

Although the display device is sealed after the inside of the vessel is evacuated, the degree of the vacuum vessel immediately after sealing is approximately 10⁻³ to 10⁻⁴ Pa. Thereafter, by performing the getter absorption (or getter flash) and aging, it is possible to increase the degree of vacuum to approximately 10⁻⁵ to 10⁻⁶ Pa.

Here, in the getter absorption step, after sealing the vessel by vacuum evacuation, the getter is heated using high frequency from the outside of the display device so as to activate the getter. The getter absorbs the residual gas. Alternatively, the getter is evaporated and the getter film is formed on the inner wall of the getter room (recessed portion 30). The gas which intrudes into the getter room via the through hole 13 is absorbed by the getter film in the inside of the getter room. In this manner, the gas in the vessel is reduced to an extent that an image display is not damaged.

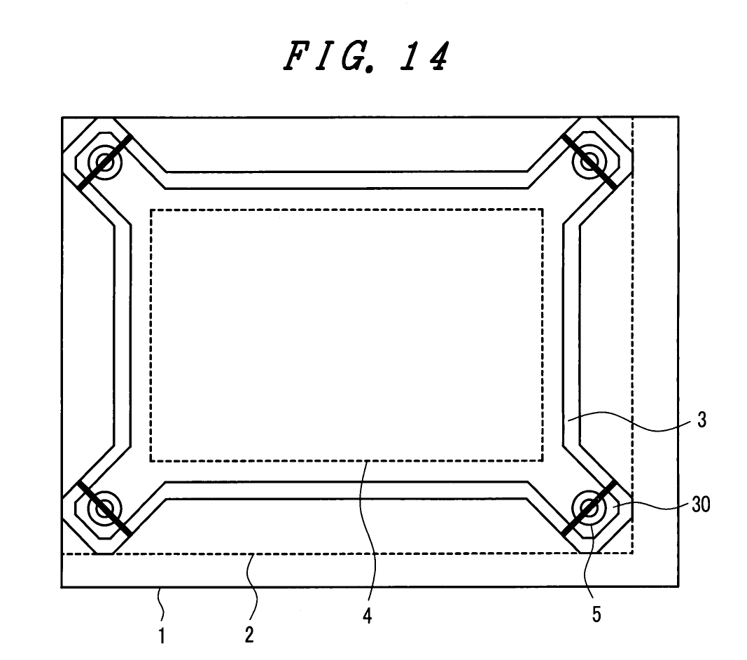

FIG. 14 is a perspective view from a front side for explaining an embodiment 4 of the display device according to the present invention. Parts identical with the parts shown in FIG. 1 are given the same symbols. In the embodiment 4, a thickness of frame 3 is approximately same in all around. Because the frame 30 of this embodiment is thin, the panel is light.

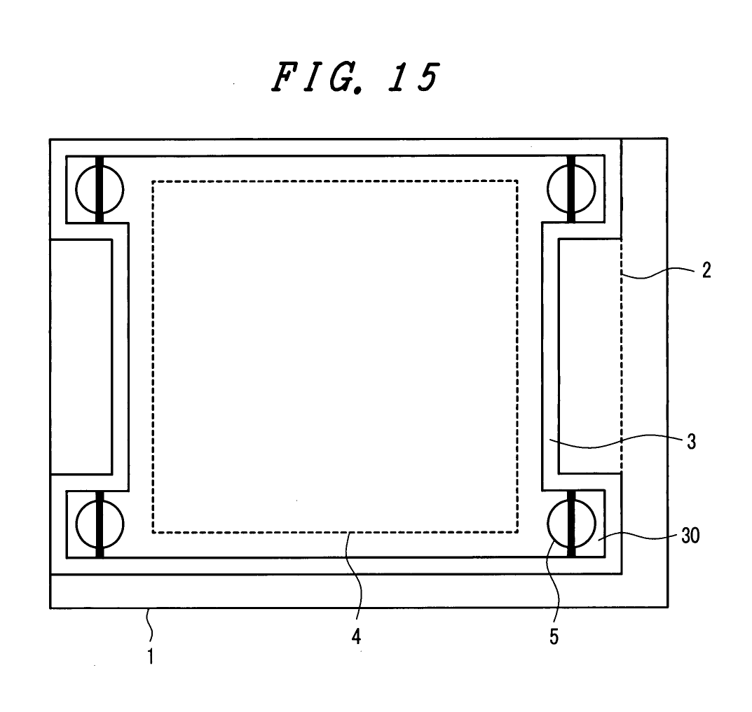

FIG. 15 is a perspective view from a front side for explaining an embodiment 5 of the display device according to the present invention. Parts identical with the parts shown in FIG. 1 are given the same symbols. In the embodiment 5, a thickness of frame 3 is approximately same in all around. Because the frame 30 of this embodiment is thin, the panel is light. A recessed portion 30 extends in horizontal directions. The length in vertical direction of panel of this embodiment is short.

What is claimed is:

1. A display device comprising an envelope which includes a back substrate having an electron emission region, a face substrate having an image display region, and a frame which connects the back substrate and the face substrate, and evacuating the inside of the envelope, wherein
a plurality of electron emission elements which are individually controlled are formed on the electron emission region,
black matrix layers, phosphor layers and an anode are formed on the image display region, and
the frame is arranged to surround the electron emission region of the back substrate and the image display region of the face substrate respectively, and
a getter assembly is arranged in the inside of the envelope, and the getter assembly is fixed to the frame.

2. A display device according to claim 1, wherein the getter assembly includes a housing for accommodating a getter material, a support which holds the housing, and a positioning rod for determining a position of the getter assembly, and the positioning rod is fixed to the frame.

3. A display device according to claim 1, wherein a notched portion in which the positioning rod is inserted is formed in a surface of the frame which faces the back substrate in an opposed manner.

4. A display device according to claim 1, wherein the frame is formed in a rectangular shape having long sides and short sides, and
the getter assembly is arranged at a corner portion of the frame.

5. A display device according to claim 4, wherein the getter assembly is arranged on extensions of inner walls of the long side and the short side of the frame which are arranged adjacent to each other.

6. A display device according to claim 1, wherein the frame is constituted of long-side members, short-side members and corner members, and the getter assembly is fixed to the corner member.
